(19) United States
(12) Patent Application Publication
(10) Pub. No.: US 2019/0024583 A1
(43) Pub. Date: Jan. 24, 2019

(54) SYSTEM AND METHOD FOR POWER PRODUCTION WITH SOLID FUEL COMBUSTION AND CARBON CAPTURE

(71) Applicant: 8 Rivers Capital, LLC, Durham, NC (US)

(72) Inventors: Xijia Lu, Durham, NC (US); Brock Alan Forrest, Durham, NC (US); Miles R. Palmer, Chapel Hill, NC (US)

(21) Appl. No.: 16/040,050

(22) Filed: Jul. 19, 2018

Related U.S. Application Data
(60) Provisional application No. 62/534,846, filed on Jul. 20, 2017.

(51) Int. Cl. F02C 3/34; F02C 3/26; F02C 6/12; F02C 7/08; F02C 7/141; F02C 6/02

(52) U.S. Cl. CPC F02C 3/34; F02C 3/26; F02C 6/12; F05D 2260/611; F02C 7/141; F02C 6/02; F02C 7/08

(57) ABSTRACT

The present disclosure relates to systems and methods useful for power production utilizing direct combustion of a solid fuel, such as coal, biomass, or the like. The systems and methods can combine a first power producing cycle that is an open loop or semi-closed loop cycle with a second power producing cycle that is a closed loop cycle utilizing a recycled working fluid, preferably CO₂. At least one stream from the open loop or semi-closed loop cycle can be used in a heating member to provide heat to the working fluid in the closed loop cycle. The solid fuel can be combusted at conditions facilitating easier removal of solids before a gaseous stream is treated and, optionally, at least partially recycled to the combustor as a recycle stream, preferably include CO₂.

### CROSS-REFERENCE TO RELATED APPLICATIONS

The present application claims priority to U.S. Provisional Patent Application No. 62/534,846, filed Jul. 20, 2017, the disclosure of which is incorporated herein by reference.

### FIELD OF THE INVENTION

The present disclosure provides systems and methods for power production with carbon capture. In particular, the systems and methods can provide for direct combustion of a solid fuel in an open or semi-closed cycle with an optional, added closed supercritical CO₂ cycle that is independent of the combustion.

### BACKGROUND

Carbon dioxide (CO₂) is a known product of the combustion of carbonaceous fuels, and power production systems utilizing combustion of carbonaceous fuels are required to capture produced CO₂. It has particularly been difficult to provide efficient power production through combustion of solid fuels, particularly coal, with simultaneous carbon capture. Coal fired power generation systems with carbon capture have been suggested in relation to supercritical pulverized coal (SCPC) with carbon capture and sequestration (CCS) or in relation to an integrated gasification combined cycle (IGCC) with CCS. Such systems, however, are plagued by high expense and low efficiency (e.g., close to 30% on a lower heating value basis). As one alternative, U.S. Pat. No. 8,596,075 to Allam et al., describes a power production system using a CO₂ working stream whereby CO₂ produced from combustion can be withdrawn at pressures corresponding to the inlet and outlet pressure of a CO₂ recycle compressor and a final CO₂ pump. While combustion of coal is contemplated in such system with a potentially higher efficiency and lower cost, a complete coal gasification system must be installed to produce coal syngas that is then combusted for power generation. The integration between a gasification system and a power production system adds complexity in the design and operation of a power plant. Moreover, the efficiency loss due to coal gasification and syngas cleanup processes cannot be avoided. Accordingly, there remains a need in the art for additional systems and methods for power production with the direct combustion of solid fuels and carbon capture.

### SUMMARY OF THE INVENTION

The present disclosure relates to systems and methods whereby direct combustion of a solid fuel can be used in power generation. By using direct combustion, the entire coal gasification, syngas cleaning, and acid gas removal systems that would otherwise be required can be eliminated according to the present disclosure. This can be accomplished, for example, by using oxy-fired coal combustion with CO₂ recycle and (optionally) in-situ sulfur removal. The combustion flue gas (which is preferably free of sulfur and ash) can be used to drive a CO₂ turbine for power generation. The heat created by coal combustion can be transferred to a closed loop supercritical CO₂ cycle for additional power generation by a solid-gas heat exchanger. Such system and method can be substantially simple in design, be implemented with relatively low cost, and exhibit relatively high efficiency, all while also achieving up to full carbon capture.

In one or more embodiments a solid fuel can be fully oxidized in a high pressure combustor with oxygen in the presence of recycled CO₂. The combustion temperature can be (in one example) in the range of about 900° C. and can be substantially controlled by the flow of the recycled CO₂ and (optionally) a flow of recycled solids. In some embodiments, limestone (CaSO₄) or a similar material can be added directly to the combustor and/or downstream of the combustor to react with and remove at least part of (and preferably substantially all of) the sulfur species, particularly SO₂ and SO₃, from the exhaust gases. As such, the heat of sulfur combustion and limestone reaction can be recovered and fully used for power generation.

The exhaust gas can be passed to a filter unit (e.g., a cyclone and/or candle filter) to remove the bulk of the solid particles (e.g., fuel ash and CaSO₄) from the exhaust gas. The solid particles removed from the cyclone will be at a temperature that is substantially close to the combustion temperature (e.g., around 900° C. in the exemplified embodiment). The solids can be passed to a solids cooler to be cooled to a lower temperature (e.g., down to about 600° C.) and then be recycled back to the combustor for temperature attenuation of the combustor.

The solids cooler can be further utilized in a closed loop CO₂ power generation cycle wherein a substantially pure CO₂ stream at a relatively high pressure (e.g., about 250 bar) can be heated in the solids cooler to a temperature that is substantially close to the temperature of the solids entering the solids cooler (e.g., about 600° C. in the exemplified embodiment). The heated CO₂ can be passed through a turbine for power generation (e.g., being expanded from a pressure of about 250 bar to a pressure of about 30 bar). The expanded CO₂ stream can be passed through a heat exchanger then re-compressed and optionally reheated by passage back through the heat exchanger before being recycled back into the solids cooler to complete the closed loop.

Additionally, a stream of substantially pure CO₂ at a pressure of about 30 bar (or higher) can be heated to a temperature of approximately 260° C. (or higher) and passed through a heat exchanger in communication with the combustor exhaust gas exiting a turbine such that it may provide low-grade heat for heat exchanger profile optimization of the power cycle.

In some embodiments, a relatively small amount of methane or natural gas with recycled CO₂ can be added into the combustion flue gas from the cyclone filter to fully remove all residual O₂. The flue gas (e.g., at a temperature of about 700° C.) can be sent to a candle filter to remove substantially all of the fine ash and alkali metal solids that may be present. The substantially ash free flue gas (in the exemplified embodiment) can be at a pressure of about 65 bar (or higher) and a temperature of about 700° C. (or higher) when leaving the filter(s) and can be used to drive an uncooled CO₂ turbine for power generation. At this point, the flue gas preferably comprises substantially only CO₂ and water, although relatively small amounts of other contaminants may be present). The turbine exhaust gas (e.g., at a temperature of about 400° C. in the exemplified embodiment) can be sent to a heat exchanger for low grade heat recuperation. Liquid water can be separated from CO₂, and the isolated CO₂ can be compressed/pumped to the requisite pressure (e.g., about 90-100 bar or higher) and recycled back to the oxy-coal combustor as the temperature moderator and aeration gas.

The present systems and methods are particularly useful in relation to the different conditions under which they can be operated. In some embodiments, the direct combustion of the solid fuel can be carried out under conditions wherein any CO₂ that is present in the combustor (e.g., the recycle CO₂) as well as any CO₂ that is produced by combustion is not in a supercritical state. In particular, the pressure in the combustor (and thus the pressure to which any recycled CO₂ is compressed/pumped) can be maintained below the CO₂ critical pressure (e.g., less than 73.9 bar). For example, combustion pressure may be about above ambient pressure and up to 73 bar or up to 70 bar or up to 65 bar. In particular, combustion pressure may be about 10 bar to about 70 bar or about 15 bar to about 60 bar. In some embodiments, the direct combustion of the solid fuel can be under conditions that allows for CO₂ entering the combustor and/or any combustion products exiting the combustor to be at a pressure such that the CO₂ is in the supercritical state. For example, recycled CO₂ can be compressed in such embodiments to a pressure that is greater than 73.9 bar, preferably greater than 80 bar (e.g., up to a maximum of about 500 bar). Likewise, combustion in such embodiments may be carried out in substantially the same pressure ranges. Thus, in some embodiments, the present disclosure can relate to power production with direct combustion of solid fuel in a semi-closed, supercritical CO₂ cycle while, in other embodiments, the present disclosure can relate to power production with direct combustion of solid fuel in a semi-closed, non-supercritical CO₂ cycle.

Introduction of the solid fuel may be done in any manner of methods. For example, it is commonplace to introduce solid fuel particles into combustion systems operating at pressures below 50 bar with lock hopper type systems. Higher pressures may use slurry injection systems and advanced high pressure solid pump systems. The resulting injection system will inherently determine the recycle CO₂ and ash flowrates given the variation in fuel to carrier/solvent ratios and chemistries.

In one or more embodiments, the present disclosure specifically can relate to a power generation system. For example, such power generation system can comprise: a first power producing cycle that is an open loop or semi-closed loop cycle, the first power producing cycle comprising: a combustor configured for combusting a solid fuel with an oxidant in the presence of a recycle CO₂ stream and outputting a combustor exhaust stream; at least one power producing member configured to receive at least a portion of the combustor exhaust stream, generate power, and output a turbine exhaust stream; and one or more elements configured for recycling at least a portion of the combustor exhaust stream back to the combustor; and a second power producing cycle that is a closed loop cycle utilizing CO₂ as a working fluid, the second power producing cycle comprising: at least one power producing member configured to receive the CO₂ working fluid and generate power; wherein the power generation system includes at least one heating member configured to receive the CO₂ working fluid from the second power producing cycle and transfer heat thereto from a stream generated from the first power producing cycle. In one or more further embodiments, the power generation system can be defined in relation to one or more of the following statements, which can be combined in any number or order.

The first power producing cycle can include a filter unit configured for removal of at least a portion of any solids present in the combustor exhaust stream.

The filter unit can include one or both of a cyclone filter and a candle filter.

The filter unit can be configured for output of a solids stream comprising at least fuel ash and a combustion flue gas stream comprising at least CO₂.

The at least one power producing member of the first power production cycle can be configured to receive the combustion flue gas stream from the filter unit.

The first power production cycle can comprise a first heat exchanger configured to withdraw heat from the turbine exhaust stream.

The power generation system further can comprise a water separator configured for receiving the turbine exhaust stream exiting the first heat exchanger and outputting a water stream and a CO₂ stream.

The power generation system further can comprise one or both of a compressor and a pump configured for pressurizing the CO₂ stream.

The first heat exchanger can comprise a hot input configured to receive the turbine exhaust stream, a cold output configured to output the turbine exhaust stream, a cold input configured to receive the CO₂ stream, and a hot output configured to output the CO₂ stream for recycle back to the combustor.

The at least one heating member can be configured to receive the CO₂ working fluid from the second power producing cycle and transfer heat thereto from a stream generated from the first power producing cycle is a solids cooler configured to receive the solids stream from the filter unit.

The power generation system further can comprise a recycle line configured for recycle of solids from the solids cooler to the combustor of the first power producing cycle.

The combustor can comprise a flame zone configured for combusting the solid fuel with the oxidant and a downstream scrubbing zone configured for receiving a sulfur scrubbing component.

The combustor can comprise a solid fuel inlet, and oxidant inlet, and a sulfur scrubbing component inlet.

The combustor further can comprise one or both of a recycle CO₂ inlet and a recycle solids inlet.

The power generation system further can comprise a scrubbing reactor downstream from the combustor, the scrubbing reactor being configured for receiving at least a portion of the combustor exhaust stream and a sulfur scrubbing component.

In particular embodiments, a power generation system according to the present disclosure can comprise at least the following: a combustor having a combustor exhaust outlet, a solid fuel inlet, an oxidant inlet and optionally one or more of a recycle CO₂ inlet, a recycle solids inlet, and a sulfur scrubbing component inlet; a filter unit having an inlet configured to receive the combustor exhaust outlet, a solids outlet, and a gas outlet for providing a combustor flue gas stream; a turbine with an inlet configured to receive the combustor flue gas stream and an outlet configured to provide a turbine exhaust; a heat exchanger having a high temperature inlet configured to receive the turbine exhaust, a low temperature outlet configured to output a cooled turbine exhaust, a low temperature inlet configured to receive a compressed, recycle CO₂ stream, and a high temperature outlet configured to output a heated, compressed recycle CO₂ stream; a water separator with a bottoms outlet configured for output of at least water and a top outlet configured for output of CO₂ gas (which is preferably substantially pure) as the recycle CO₂ stream; at least one compressor or pump having an inlet configured to receive the recycle CO₂ stream at a relatively lower pressure and an outlet configure to output the recycle CO₂ stream at a relatively higher pressure (the pressure at one of the inlet and the outlet being relative to the other of the inlet and the outlet); a heater component having a high temperature inlet configured to receive a stream of solids from the filter unit, a low temperature outlet configured for output of a cooled stream of the solids, a low temperature input for receiving a working fluid, and a high temperature outlet for output of the working fluid at a higher temperature; a turbine with an inlet configured for receiving the working fluid from the high temperature outlet of the heater component and an outlet configured for exit of a lower pressure turbine exhaust; at least one compressor or pump having an inlet configured to receive the working at a relatively lower pressure and an outlet configure to output the working fluid at a relatively higher pressure (the pressure at one of the inlet and the outlet being relative to the other of the inlet and the outlet); and a heat exchanger having a high temperature inlet configured to receive the working fluid from the turbine outlet, a low temperature outlet configured to output a cooled working fluid stream, a low temperature inlet configured to receive a compressed, working fluid stream, and a high temperature outlet configured to output a heated, compressed working fluid stream for passage to the low temperature input of the heater component; and a plurality of pipes, tubing, or other lines suitable for passage of the streams between the noted components of the system. Additionally, one or more splitters and/or mixers may be included to separate or combine one or more streams. Additionally, a sulfur scrubbing reactor may be positioned between the combustor and the filter unit and may include an input for receiving the combustor exhaust stream, an input for receiving a sulfur scrubbing component, and an output for exit of scrubbed combustor exhaust for passage to the filter unit. The two heat exchangers listed above may be substituted with a single, unified heat exchanger having the recited inputs and outputs.

In one or more embodiments, the present disclosure further can provide methods for power generation. For example, a method for power generation can comprise: combusting a solid fuel in a combustor with an oxidant in the presence of a compressed, recycle CO₂ stream to form a combustor exhaust stream; filtering the combustor exhaust stream in a filter unit to remove solids from the combustor exhaust stream and provide a combustor flue gas stream; passing the combustor flue gas stream through a first turbine for power generation to provide a turbine exhaust stream; processing the turbine exhaust stream to provide the compressed, recycle CO₂ stream to the combustor; transferring the solids removed from the combustor exhaust stream to a heating member; and circulating a CO₂ working fluid through a closed loop cycle such that the CO₂ working fluid is compressed, heated with heat from the solids in the heating member, and expanded through a second turbine for power generation. In one or more further embodiments, the methods of generating power can be defined in relation to one or more of the following statements, which can be combined in any number and order.

The combusting can be carried out at a temperature of about 600° C. to about 1,200° C.

The combusting can be carried out at a pressure that is above ambient and up to about 70 bar.

The combusting can be carried out such that substantially none of the CO₂ present in the combustor is in a supercritical condition.

The combusting can be carried out at a pressure of about 80 bar to about 500 bar.

Prior to said filtering, the method further can comprise adding a sulfur scrubbing component (e.g., a CaCO₃ containing material) to the combustor exhaust stream.

Prior to said passing the combustor flue gas stream through the first turbine, the method further can comprise adding an amount of gaseous fuel to the combustor flue gas stream.

The processing the turbine exhaust stream to provide the compressed, recycle CO₂ stream can comprise: cooling the turbine exhaust stream in a recuperator heat exchanger; passing a cooled turbine exhaust stream from the recuperator heat exchanger through a water separator to output a water stream and a stream of substantially pure CO₂; compressing the stream of substantially pure CO2 to a pressure suitable for input to the combustor; and heating the stream of substantially pure CO₂ in the recuperator heat exchanger using at least heat withdrawn from the turbine exhaust that was cooled.

The compressing can comprise using one or both of a compressor and a pump.

The turbine exhaust can be passed into the recuperator heat exchanger through a hot input, the cooled turbine exhaust stream can exit the heat exchanger through a cold output, the stream of substantially pure CO₂ can enter the recuperator exchanger through a cold input, and the stream of substantially pure CO₂ can exit the recuperator exchanger through a hot output for recycle back to the combustor.

The filter unit can include one or both of a cyclone filter and a candle filter.

The solids removed from the combustor exhaust stream and transferred to the heating member can be at least partially recycled back to the combustor.

### BRIEF DESCRIPTION OF THE DRAWINGS

FIG. 1 provides a schematic view of a system configured for carrying out a power generation method according to embodiments of the present disclosure.

FIG. 2 provides a schematic view of a further system configured for carrying out a power generation method according to embodiments of the present disclosure

### DETAILED DESCRIPTION

The present subject matter will now be described more fully hereinafter with reference to exemplary embodiments thereof. These exemplary embodiments are described so that this disclosure will be thorough and complete, and will fully convey the scope of the subject matter to those skilled in the art. Indeed, the subject matter can be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present disclosure relates to systems and methods for power production. In one or more embodiments, such systems and methods can be configured so that a solid fuel can be combusted in a pressurized combustor with an oxidant in the presence of one or more additional input streams. The solid fuel can be any solid material suitable for combustion in a power production cycle including, but not limited to, one or more grades of coal, pet coke, bitumen, biomass, and the like. The oxidant can be any oxygen source including an increased oxygen content (e.g., greater than the oxygen content in ambient air) and preferably is substantially pure oxygen (e.g., having an oxygen content of at least 95 mol %, at least 98 mol %, or at least 99 mol %). Substantially pure oxygen may be created on-site, such as by using an air separation unit or other oxygen production equipment, or substantially pure oxygen may be piped into the system. The oxidant may be input directly to the combustor or it may be diluted in a diluent stream (e.g., at a mol ratio of about 20/80 oxidant/diluent to about 60/40 oxidant/diluent or about 30/70 oxidant/diluent to about 50/50 oxidant/diluent). One or more additional input streams specifically can include at least a stream of recycled CO₂. Such recycled CO₂ likewise can be a preferred diluent for the oxidant. In some embodiments, the additional input streams may include a water (or steam) stream and/or a stream of recycled fuel ash.

A variety of combustors may be utilized in the present systems and methods. For example, the combustor can be a dry-ash combustor, a slagging type combustor, a fluidized bed combustor, or a film and/or transpiration cooled combustor. The combustor particularly may be configured for accommodating a high ash content fuel where the ash functions essentially as a coolant. Likewise, the combustor may be configured for accommodating the input of fuel, oxidant, and one or more recycle streams that function as a coolant (e.g., recycled CO₂, water, and/or ash). In further embodiments, the combustor can be configured for receiving oxidant and fuel, wherein the fuel is entrained in a coolant (e.g., water, CO₂, or the like) and no additional input stream is required. In such embodiments, no additional input stream is required for quenching or otherwise cooling the combustion process in light of the inherent coolant content of the fuel slurry. Useful combustors may include at least a plurality of inputs for receiving the input streams, a combustion zone (or flame zone) wherein a majority of the combustion of the fuel is carried out, and optionally a post-combustion zone (or post-flame zone) where additional inputs may be delivered for modifying the combustor exhaust product (e.g., to reduce the temperature of the combustor exhaust, to modify the chemistry of the combustor exhaust, or the like). In a preferred embodiment, the combustor can be a fluidized bed combustor with a scrubbing zone downstream of a combustion zone, the scrubbing zone being particularly configured for receiving a stream comprising limestone as a scrubbing component.

The combustion pressure is above ambient pressure and thus can be, for example, about 10 bar to about 500 bar, about 10 bar to about 300 bar, or about 60 bar to about 150 bar. In some embodiments, the combustion pressure may be about above ambient pressure and up to 73 bar, up to about 70 bar, or up to about 65 bar. In particular, combustion pressure may be about 10 bar to about 70 bar or about 15 bar to about 60 bar. Such conditions may be referred to as non-supercritical combustion conditions (i.e., such that any CO₂ present in the system is not in a supercritical condition). In some embodiments, the direct combustion of the solid fuel can be under conditions that allows for CO₂ entering the combustor and/or any combustion products exiting the combustor to be at a pressure such that the CO₂ is in the supercritical state. For example, combustion may be carried out in a range of about 80 bar to about 500 bar, about 100 bar to about 450 bar, or about 150 bar to about 400 bar. Such conditions may be referred to as supercritical combustion conditions (i.e., such that any CO₂ present in the system is in a supercritical condition). Higher pressure may be utilized to take advantage of smaller equipment size and lower capital cost as well as improved performance. Lower pressures, however, may also be used.

In carrying out the combustion process, the oxidant is injected into the combustor in a condition such that it is preferably substantially free of any nitrogen, which is why substantially pure oxygen can be preferred. The solid fuel is injected into the combustor separate from the oxidant and may be provided in a slurry with a slurry medium (e.g., CO₂, water, or a mixture thereof, or the like) or in any other flowable form (including a dry-fed form with recycled CO₂ as a feeding gas). One or more additional streams may be provided to control the operating temperature of the combustor within the desired combustion temperature range so that the combustor exit temperature does not exceed acceptable operating conditions of the downstream equipment. For example, one or more of recycled CO₂, water, recycled fuel ash, and limestone can be injected into the combustor as one or more additional input streams and/or in some combination with the fuel itself. The combustion temperature is preferably maintained within a range of about 600° C. to about 1,200° C., about 700° C. to about 1,100° C., or about 800° C. to about 1,000° C. As such, the exit temperature of the combustor exhaust stream will be within such ranges. Preferentially, combustion is carried out below the ash melting temperature so that substantially all ash present in the combustor exhaust stream is in a substantially solid state.

A sulfur scrubbing component, such as lime, limestone, or the like can be injected into a post-flame zone in the combustor to scrub out sulfur species that were originally present (such as is often found in coal). Materials containing calcium carbonate (CaCO₃) in particular are useful for reacting with sulfur-containing species (e.g., SO₂ and SO₃) present in many solid fuel materials (particularly coal) to form solid calcium sulfate (CaSO₄) that can be filtered from the combustor exhaust. A sulfur scrubbing component (such as limestone) that is injected into the combustor can be dry-fed with recycled CO₂ as feeding gas, or slurry-fed with mixing water, supercritical CO₂, or a mixture thereof. Dry injection can be via a lockhopper system or a solid pump system, and a slurry pump can be used for injection of a slurried solid (e.g., limestone/water slurry). Injection need not be directly into the combustor in some embodiments. For example, when high temperature combustion (e.g., greater than about 1,000° C.) is utilized such that the ash can be present at least partially in a liquid state (e.g., a slagging combustor), it can be beneficial to first cool the combustor exhaust prior to introduction of the sulfur scrubbing component. In such embodiments, the combustor exhaust can be first be quenched below the solidification temperature of the liquefied ash components. Such quenching can be achieved, for example, through input of recycled solids and/or recycled CO₂ to the combustor. The combustor exhaust also may be passed through a quenching unit or other cooler that is separate from the combustor. Alternatively, solidification may take place at least partially within a transfer line between the combustor and a secondary reactor wherein the sulfur scrubbing component can be added to the cooled combustor exhaust. In preferred embodiments, the sulfur scrubbing component is added directly to the combustor downstream from the flame zone or combustion chamber so that sulfur species are substantially completely removed from the combustor exhaust gases before exiting the combustor.

The combustor is preferably operated in an oxygen rich condition to ensure a stoichiometrically complete combustion. In some embodiments, a membrane wall filled with clean CO₂ can be installed in the combustor to control the combustion temperature.

At least one filter element is preferably includes downstream from the combustor in order to remove at least a portion, at least a majority, or substantially all of any fuel ash and other solids (e.g., CaSO₄ present from the reaction of limestone with sulfur species present in the solid fuel) in the combustor exhaust stream. The at least one filter element preferably is immediately downstream from the combustor so that the combustor exhaust stream is filtered of solids before passing into any further components of the power production system. In certain embodiments, a cyclone filter in particular is installed at the exit of the combustor to remove a bulk of fuel ash and CaSO₄. Solids captured by the at least one filter element (e.g., fuel ash and CaSO₄) typically will be at a temperature that is substantially in the range of the combustor exhaust stream temperature, as noted above.

The solids removed in the at least one filter element can be passed to a solids cooler to recuperate heat therefrom for additional power production. For example, a solid-gas heat exchanger can be used as the solids cooler to remove high grade heat from the solid particles, which solids them may be recycled back to the combustor in total or in part and/or removed from the system in whole or in part. The solid gas heat exchanger, for example, can be a fluidized bed or moving bed cooler with tubing inside. In operation, a high pressure (e.g., about 100 bar to about 400 bar or about 200 bar to about 300 bar) stream of substantially pure CO₂ can be heated (e.g., to a temperature of up to about 900° C., up to about 800° C., or up to about 700° C., more particularly in the range of about 500° C. to about 900° C., or about 600° C. to about 800° C., depending upon the combustor exhaust temperature) in the solids heater to provide a closed loop CO₂ power generation cycle operating within the overall power cycle.

As noted above, the solids (e.g., fuel ash and CaSO₄) exiting the solids cooler in whole or in part can be recycled back to the combustor as a temperature moderator. The amount of the recycled solids is determined by the combustion temperature and the amount of the recycled CO₂ that is utilized. Both recycled solid particles and recycled CO₂ can be the temperature moderator for the solid fuel combustion. Higher amounts of the recycled solids can be used in order to increase the magnitude of the solids cooler and thus the closed-loop, substantially pure CO₂ power generation train (i.e., formed of a pure CO₂ compressor, a substantially pure CO₂ pump, and a substantially pure CO₂ turbine). On the other hand, higher amounts of recycled combustion derived CO₂ leads to an increase in the magnitude of any flue gas cleaning system (e.g., combustor, cyclone filter, and/or candle filter) and open loop combustion derived CO₂ power generation train (e.g., the combustion derived CO₂ compressor, combustion derived CO₂ pump, and combustion derived CO₂ turbine). The mass ratio of the recycled solids to the recycled CO₂ can be determined by the optimal levelized cost of electricity (LCOE) number of the overall power system.

In one or more embodiments, the presently disclosed power production system and method can have an overall configuration such that the system and method can be considered to be an open loop (or semi-closed) combustion derived CO₂ power generation train. In such embodiments, as already described above, solid fuel, oxidant, and any additional streams are input to the combustor so that the fuel is combusted to form a combustor exhaust stream. The combustor exhaust stream is then passed through one or more filter elements to remove solids from the combustor exhaust stream. The removed solids are utilized as otherwise described above, and a combustion flue gas passes from the filter to the remaining components of the power production system. The combustion flue gas can comprise, for example, at least 50%, at least 75%, at least 85%, or at least 90% by mass CO₂ and can includes a lesser mass content of steam, oxygen, and optionally further contaminants. The combustion flue gas exiting the filter(s) can be at a temperature that remains substantially close to the temperature of the combustor exhaust stream (e.g., in a range of about 600° C. to about 1,100° C., about 800° C. to about 1,000° C., or about 850° C. to about 950° C.).

If needed, a relatively small amount of gaseous fuel (e.g., natural gas or methane, optionally mixed with recycled CO₂) may be blended with the flue gas to scavenge any oxygen remaining therein and to reduce the flue gas temperature (e.g., a temperature reduction of about 100° C. to about 300° C. or about 150° C. to about 250° C.). The temperature reduction is preferably effective such that a majority, or substantially all, of any Alkali metal components, such as NaSO₄, NaCO₃ and MeSO₄, will solidify. If needed, a further filter element (e.g., a cyclone filter and/or a candle filter) can be utilized to remove substantially all fine ash and trace alkali metal solids from the combustion flue gas.

After all treatment of the combustor exhaust and the combustion flue gas to remove solids and other components thereof, the remaining combustion flue gas is directed to a turbine for power generation. The turbine, for example, may be an un-cooled turbine; however, if operating conditions require, the turbine may be cooled, such as by directing a stream of the recycled CO₂ through the turbine casing. The turbine is coupled to a power generator, particularly for the production of electrical energy.

The turbine exhaust stream (which now can be at a temperature of less than about 500° C., such as in the range of about 400° C. to about 500° C.) is sent to a heat exchanger to be cooled, such as to a temperature of less than about 100° C., less than about 50° C., or less than about 40° C., and preferably down to around ambient temperature. Cooling is preferably sufficient such that liquid water as well as any trace amounts of SOx and/or NOx present in the turbine exhaust is separated from CO₂ in a water separator. The water separator will thus have a bottoms outlet for removal of liquid water and the components entrained therein and a recycle outlet for output of recycled CO₂. An activated carbon bed absorber can be present at the recycle outlet of the water separator in order to remove heavy metals, such as mercury, from the CO₂ stream. The CO₂ exiting the water separator is preferably substantially pure (i.e., greater than 90 mol %, greater than 95 mol %, greater than 98 mol %, or greater than 99 mol %). The clean, substantially pure CO₂ is compressed and pumped to the combustion pressure. A portion of the CO₂ can be withdrawn from the system for inventory control and carbon capture. The rest of the high pressure CO₂ is pre-heated against the turbine exhaust stream in the heat exchanger before being recycled back to the solid fuel combustor.

In addition to the overall power cycle, in some embodiments, the presently disclosed systems and method can further provide a closed loop CO₂ power generation train. In particular, the present disclosure can provide an open loop or semi-closed loop CO₂ power generation train with an embedded closed loop CO₂ power generation train. As noted above, in such embodiments, solids (e.g., fuel ash/CaSO₄) removed from the combustor exhaust stream can be recycled back to the coal combustor to remove the combustion heat and control the operating temperature. The combustion heat present in the solids that are removed in the filter(s) present immediately downstream of the combustor is transferred into a closed loop CO₂ train in the aforementioned solid-gas heat exchanger. The substantially pure, high pressure CO₂ working fluid (which remains uncontaminated by any combustion products) is heated in the solids cooler. If desired, the temperature of the substantially pure CO₂ stream can be further increased (e.g., by about 50° C. to about 300° C. or by about 100° C. to about 200° C.) by directing the CO₂ into a membrane wall present in the coal combustor. The membrane wall can be present between the outer casing of the combustor and the interior combustion chamber so that heat of combustion can be transferred to the CO₂ stream passing around the membrane wall. The high temperature, high pressure CO₂ exiting the membrane wall is directed to a closed loop turbine for power generation. The CO₂ working fluid entering the turbine preferably is at a temperature of about 400° C. to about 1,000° C., about 500° C. to about 900° C., or about 600° C. to about 800° C. In the turbine, the CO₂ working fluid is expanded from a high inlet pressure (e.g., about 100 bar to 400 bar, about 150 bar to about 300 bar, or about 200 bar to about 300 bar) to a low outlet pressure (e.g., about 5 bar to about 90 bar, about 10 bar to about 80 bar, or about 15 bar to about 50 bar). The turbine exhaust stream is directed to a heat exchanger for heat recuperation before being compressed and pumped back to the turbine inlet pressure. The CO₂ at pump exit goes through the CO₂ heat recuperator, solid cooler and/or combustor membrane wall to be preheated to the turbine inlet temperature. The working fluid in the closed loop train can be substantially pure CO₂, steam, or a mixture of CO₂ and H₂O. The working fluid in the closed loop train is preferably never in contact with the open loop combustion derived CO₂ to avoid contamination.

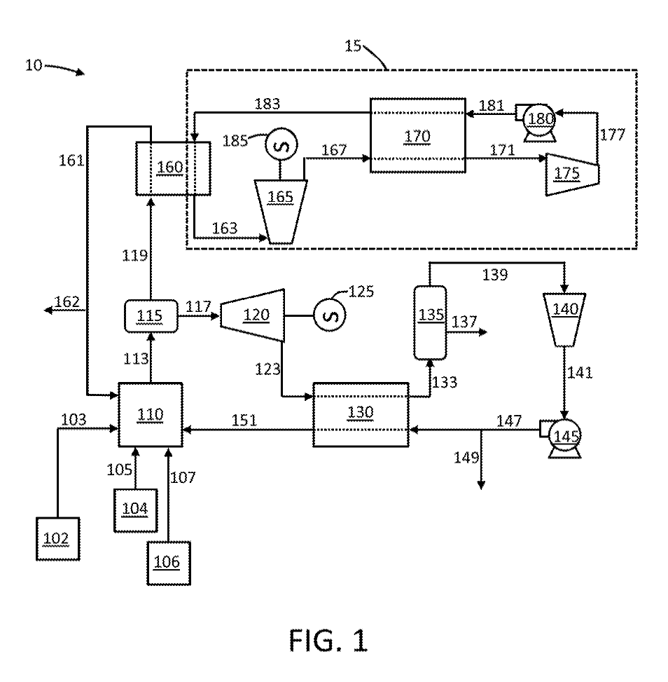

An exemplary power production system 10 for carrying out a power production method according to the present disclosure is illustrated in FIG. 1. As shown therein, a solid fuel combustor 110 (which may be referenced as an oxy-fuel combustor) is configured for receiving an oxidant in line 103 from oxidant source 102 and for receiving a fuel in line 105 from solid fuel source 104. The solid fuel source 104 may include elements that are not illustrated but are understood in the art, such as one or more crushers for particularizing the solid fuel. Optionally, a sulfur scrubbing material may be provided to the combustor 110 through line 107 from a sulfur-scrubbing material source 106. Again, the sulfur scrubbing material source 106 may include elements that are not illustrated but are understood in the art, such as one or more crushers for particularizing a solid material, such as limestone. The fuel from line 105 is combusted in the combustor 110 with the oxidant from line 103 to form the combustor exhaust exiting the combustor in line 113. The sulfur scrubbing material particularly can be added to a scrubbing zone that is present in the combustor 110 downstream from a combustion chamber or flame zone. As such, fuel and oxidant may be input at an upstream position (relative to the scrubbing zone) in the combustor 110, and the sulfur scrubbing material can be input as a downstream position (relative to the flame zone or combustion chamber) in the combustor. Alternatively, the sulfur scrubbing material passing through line 107 may be added to a downstream reactor, and the combustor exhaust in line 113 may be passed through the reactor before passage to the further elements described below.

The combustor exhaust in line 113 is passed to the filter unit 115, which can be comprised of a single filter or a plurality of different filters (e.g., one or both of a cyclone filter and a candle filter). Solids (e.g., fuel ash and CaSO₄) present in the combustor exhaust are removed in the filter unit 115, and the remaining combustion flue gases exit the filter unit in line 117. The combustor flue gas in line 117 is passed through the turbine 120 to generate power in generator 125, and the expanded combustor flue gas exits the turbine as turbine exhaust in line 123. The turbine 120 may be referenced as a first turbine, a primary turbine, or an open-loop turbine. Prior to passage through the turbine, the combustor flue gas may be combined with a further content of oxygen to ensure complete reaction of all reactive species in the combustor flue gas, and such reaction may take place in-line and/or in a further reaction chamber.

The expanded turbine exhaust exiting the first turbine 120 in line 123 is passed through the recuperator heat exchanger 130 to cool the turbine exhaust and provide heat to one or more further streams. The recuperator heat exchanger 130 may be referenced as a first heat exchanger, a primary heat exchanger, or an open-loop heat exchanger. The cooled turbine exhaust exits the first heat exchanger 130 in line 133 and passes to a water separator 135 for purification of the CO₂ in the turbine exhaust stream. Water and any entrained elements (e.g., SOx, NOx, and/or metals) are withdrawn through line 137, and substantially pure CO₂ exits the water separator 135 in line 139. The substantially pure CO₂ in line 139 is first compressed in first compressor 140 (which may referenced as an open or semi-closed loop compressor) before passing through line 141 to first pump 145 (which may be referenced as an open or semi-closed loop pump) to form the recycle CO₂ stream in line 147 at a pressure suitable for input back to the combustor 110. A fraction of the recycle CO₂ in line 147 may be withdrawn from the system through CO₂ product line 149. Additionally, or alternatively, product CO₂ may be withdrawn at different pressures from line 139 and/or line 141. The recycle CO₂ in line 147 is heated by passage back through the first heat exchanger 130 to exit as line 151 for recycle back into the combustor 110. If desired, a portion of the recycle CO₂ in line 151 and/or line 147 and/or line 141 may be withdrawn and added to line 105 and/or line 107 for use as a transfer medium for facilitating flow of the solid fuel in line 105 and/or the flow of the sulfur scrubbing material in line 107 to the combustor 110. Likewise, if desired, a portion of the recycle CO₂ in line 151 and/or line 147 and/or line 141 may be withdrawn and added to line 103 for use as a diluent for the oxidant in line 103.

Solids (e.g., fuel ash and CaSO₄) present in the combustor exhaust in line 113 are removed in the filter unit 115 and passed therefrom through line 119 to the solids cooler 160. The solids exit the solids cooler 160 in line 161 and may be passed therethrough for recycling back to the combustor 110. All or a portion of the solids in line 161 may be withdrawn through solids product line 162.

Heat withdrawn in the solids cooler 160 is utilized for heating in the closed loop power production train 15 (shown within the dashed line box in FIG. 1). A working fluid is circulated through lines 163, 167, 171, 177, 181, and 183, and the working fluid remains isolated from physical contact with the solids passing from line 119 through the solids cooler 160. In particular, the heated and compressed working fluid (e.g., substantially pure CO₂, water, or a mixture of CO₂ and water) in line 183 is passed through the solids cooler 160 for further heating with the heat withdrawn from the solids form line 119. The superheated working fluid stream passes through line 163 to a turbine 165 for power generation with generator 185. The turbine 165 may be referenced as a second turbine, a secondary turbine, or a closed-loop turbine. The working fluid exits the second turbine 165 through line 167 and is cooled in heat exchanger 170. The heat exchanger 170 may be referenced as a second heat exchanger, a secondary heat exchanger, or a closed-loop heat exchanger. The cooled working fluid exits the second heat exchanger 170 in line 171 and passes to a second compressor 175 (which may be referenced as the closed-loop compressor) to be compressed to an intermediate pressure before passing through line 177 to a second pump (which may be referenced as the closed-loop pump). The working fluid, now pumped to the desired pressure, is passed through line 181 back to the second heat exchanger 170, and the heated, compressed working fluid exits through line 183 for passage back through the solids cooler 160. Although a second heat exchanger 170 is shown in FIG. 1, it is understood that heating may be carried out utilizing the first heat exchanger 130 additionally or in the alternative.

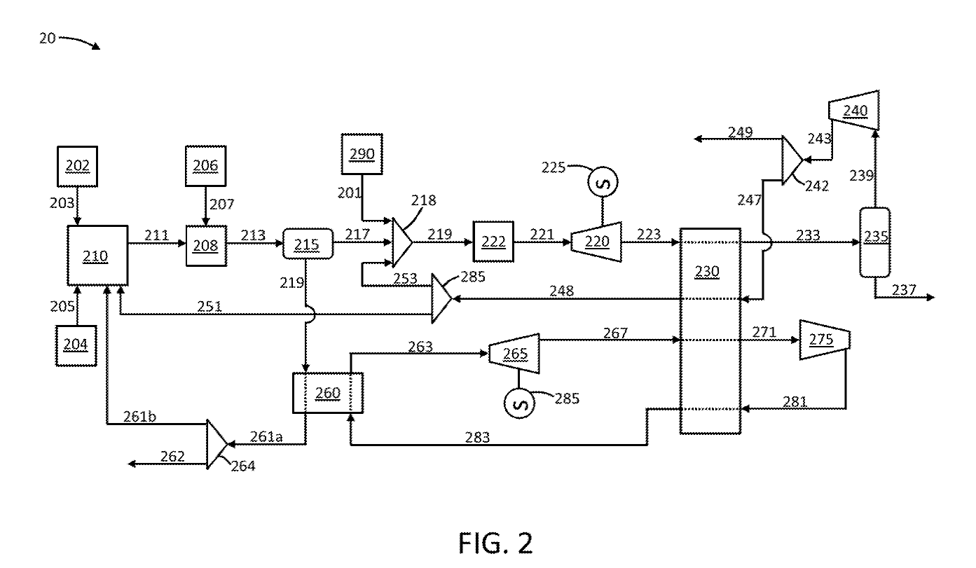

An exemplary power production system 20 for suitable for carrying out a power production method according to embodiments of the present disclosure is illustrated in FIG. 2. Specific reaction parameters described below in relation to FIG. 2 are understood to be exemplary and should not be viewed as limiting. Rather, reaction parameters may otherwise be within the ranges otherwise described herein. In the exemplary embodiment shown in FIG. 2, a solid fuel combustor 210 is configured for receiving an oxidant in line 203 at a temperature of about 18° C. and a pressure of about 100 bar from oxidant source 202 (e.g., an air separation unit or other source) and for receiving a fuel in line 205 at a temperature of about 34° C. and a pressure of about 100 bar from solid fuel source 204. The solid fuel source 204 may include elements that are not illustrated but are understood in the art, such as one or more crushers for particularizing the solid fuel. The fuel from line 205 is combusted in the combustor 210 with the oxidant from line 203 to form the combustor exhaust exiting the combustor in line 211 at a temperature of about 909° C. and a pressure of about 68 bar.

The combustor exhaust in line 211 is passed to a mixer/reactor 208 to which a stream of limestone (or other sulfur-scrubbing material) is provided through line 207 at a temperature of about 38° C. and a pressure of about 100 bar from limestone source 206. Again, the limestone source 206 may include elements that are not illustrated but are understood in the art, such as one or more crushers for particularizing the limestone. The mixer/reactor 208 (which may be described as a scrubbing reactor) is thus positioned downstream from the combustor 210, and the scrubbing reactor is configured for receiving at least a portion of the combustor exhaust stream and a sulfur scrubbing component.

The combustor exhaust exiting the limestone mixer/reactor 208 in line 213 at a temperature of about 909° C. and a pressure of about 68 bar is passed to the filter unit 215, which can be comprised of a single filter or a plurality of different filters (e.g., one or both of a cyclone filter and a candle filter). Solids (e.g., fuel ash and CaSO₄) present in the combustor exhaust are removed in the filter unit 215, and the remaining combustion flue gases exit the filter unit in line 217 at a temperature of about 909° C. and a pressure of about 66 bar. The combustor flue gas in line 217 passes through a mixer 218 where it is combined with recycle CO₂ from line 253 at a temperature of about 427° C. and a pressure of about 97 bar and an amount of a gaseous fuel (e.g., methane or natural gas) from a gaseous fuel source 290 through line 201 at a temperature of about 38° C. and a pressure of about 87 bar. The added gaseous fuel can be useful to ensure complete reaction of any remaining oxidant in the combustor flue gas. Such reaction may take place in the mixer 218 and/or in line 219. As illustrated, the mixture of combustor flue gas, gaseous fuel, and recycle CO₂ in line 219 at a temperature of about 680° C. and a pressure of about 66 bar passes to an oxidizing reactor 222, and oxidization of the added gaseous fuel by any remaining oxidant may be substantially completely carried out before the combustor flue gas exits the oxidizing reactor.

The combustor flue gas exits the oxidizing reactor 222 in line 221 at a temperature of about 714° C. and a pressure of about 66 bar and is passed through the turbine 220 to generate power in generator 225, and the expanded combustor flue gas exits the turbine as turbine exhaust in line 223 at a temperature of about 453° C. and a pressure of about 15 bar. The turbine 220 may be referenced as a first turbine, a primary turbine, or an open-loop turbine.

The expanded turbine exhaust exiting the first turbine 220 in line 223 is passed through the recuperator heat exchanger 230 to cool the turbine exhaust and provide heat to one or more further streams. The cooled turbine exhaust exits the recuperator heat exchanger 230 in line 233 at a temperature of about 43° C. and a pressure of about 12 bar and passes to a water separator 235 for purification of the CO₂ in the turbine exhaust stream. Water and any entrained elements (e.g., SOx, NOx, and/or metals) are withdrawn through line 237 at a temperature of about 18° C. and a pressure of about 11.5 bar, and substantially pure CO₂ exits the water separator 235 in line 239 at a temperature of about 18° C. and a pressure of about 11.5 bar. The substantially pure CO₂ in line 239 is compressed in a first compressor 240 (which may referenced as an open or semi-closed loop compressor) and exits in line 243 at a temperature of about 94° C. and a pressure of about 100 bar. The first compressor 240 may be, for example, a multi-stage compressor (e.g., having at least compression stages) which may or may not be intercooled. The substantially pure CO₂ in line 239 is passed through a first splitter 242 to provide a vent stream in line 249 at a temperature of about 94° C. and a pressure of about 100 bar and to provide a stream of recycle CO₂ in line 247 at a temperature of about 94° C. and a pressure of about 100 bar.

The recycle CO₂ in line 247 is heated by passage back through the recuperator heat exchanger 230 to exit as line 248 at a temperature of about 427° C. and a pressure of about 97 bar. The recycle CO₂ in line 247 passes through a second splitter 285 to provide the CO₂ stream in line 253 for input to the mixer 218. The remaining recycle CO₂ in line 251 at a temperature of about 427° C. and a pressure of about 97 bar is recycled back into the combustor 210. If desired, a portion of the recycle CO₂ in line 251 and/or line 248 and/or line 247 and/or line 243 may be withdrawn and added to line 205 and/or line 207 for use as a transfer medium for facilitating flow of the solid fuel in line 205 and/or the flow of the limestone in line 207 to the mixer/reactor 208. Likewise, if desired, a portion of the recycle CO₂ in line 251 and/or line 248 and/or line 247 and/or line 243 may be withdrawn and added to line 203 and/or line 201 for use as a diluent for the oxidant.

Solids (e.g., fuel ash and CaSO₄) present in the combustor exhaust in line 213 are removed in the filter unit 215 and passed therefrom through line 219 at a temperature of about 909° C. and a pressure of about 97 bar to the solids cooler 260. The solids exit the solids cooler 260 in line 261a at a temperature of about 649° C. and a pressure of about 65.5 bar and may be passed therethrough for recycling back to the combustor 210. As illustrated, the solids in line 261a are passed through a second splitter 264 to provide a vent solids stream in solids product line 262 at a temperature of about 649° C. and a pressure of about 65.5 bar and to provide a stream of recycle solids that are passed through line 261b at a temperature of about 649° C. and a pressure of about 65.5 bar back to the combustor 210. All or a portion of the solids in line 261a may be withdrawn through solids product line 262. Likewise, all or a portion of the solids in line 261a may be recycled back to the combustor in line 261b.

Heat withdrawn in the solids cooler 260 is utilized for heating in the closed loop power production train. A working fluid is circulated through lines 263, 267, 271, 281, and 283, and the working fluid remains isolated from physical contact with the solids passing from line 219 through the solids cooler 260. In particular, the heated and compressed working fluid (e.g., substantially pure CO₂, water, or a mixture of CO₂ and water) in line 283 at a temperature of about 316° C. and a pressure of about 247 bar is passed through the solids cooler 260 for further heating with the heat withdrawn from the solids form line 219. The superheated working fluid stream passes through line 263 at a temperature of about 714° C. and a pressure of about 244 bar to a turbine 265 for power generation with generator 285. The turbine 265 may be referenced as a second turbine, a secondary turbine, or a closed-loop turbine. The working fluid exits the second turbine 265 through line 267 at a temperature of about 378° C. and a pressure of about 30 bar and is cooled in the recuperator heat exchanger 230. Alternatively, a second, separate heat exchanger may be used exclusively as a closed-loop heat exchanger. The cooled working fluid exits the recuperator heat exchanger 230 in line 271 at a temperature of about 43° C. and a pressure of about 27 bar and passes to a second compressor 275 (which may be referenced as the closed-loop compressor) to be compressed. The second compressor 270 may be, for example, a multi-stage compressor (e.g., having at least compression stages) which may or may not be intercooled.

The working fluid, now compressed to the desired pressure, is passed through line 281 at a temperature of about 39° C. and a pressure of about 250 bar back to the recuperator heat exchanger 230, and the heated, compressed working fluid exits through line 283 for passage back through the solids cooler 260.

### Example

A power production cycle was modeled utilizing a system as described herein to evaluate the process efficiency. The modeling considered the following parameters and provided operational values as shown in the table thereafter.

A fluidized bed combustor (110, 210) with two cyclones is operated at a pressure of about 68 bar and a temperature of about 900° C.

A solids cooler (160, 260) is operated across a cooling range of about 900° C. to about 650° C. to preheat the CO₂ working fluid in the closed-loop power cycle train at a pressure of about 250 bar (actual inlet flow rate of 4.6 m³/s) from a temperature range of about 315° C. to about 650° C.

Candle filter (115, 215) is operated at a temperature of about 700° C. and a pressure of about 66 bar (11 m³/s actual flow rate).

An uncooled turbo expander (120, 220) is operated at a temperature of about 700° C. and expands the combustor flue gas across a pressure range of about 66 bar to about 15 bar (354 kg/s flow rate).

A recuperator heat exchanger is operated at about 456° C. and a pressure of about 250 bar with a UA of 59,976,763.5 btu/hr-R and an LMTD of 34.2.

A CO₂ working fluid compressor/pump is operated across a compression range of about 11.5 bar to about 100 bar with a 212 kg/s flow rate.

A closed loop CO₂ working fluid expander is operated at a temperature of about 700° C. across a pressure range of about 246 bar to about 30 bar with a 1033 kg/s flow rate.

| | |
|---|---|
| Thermal input (MW LHV) | 637 |
| Gross Power (MW) | 508.8 |
| ASU power usage (MW) | 70 |
| Compressor/pump/other power usage | 116.6 |
| Net Power (MW) | 322 |
| Efficiency | 50.5% |

Many modifications and other embodiments of the presently disclosed subject matter will come to mind to one skilled in the art to which this subject matter pertains having the benefit of the teachings presented in the foregoing descriptions and the associated drawings. Therefore, it is to be understood that the present disclosure is not to be limited to the specific embodiments described herein and that modifications and other embodiments are intended to be included within the scope of the appended claims. Although specific terms are employed herein, they are used in a generic and descriptive sense only and not for purposes of limitation.

1. A power generation system comprising:
a first power producing cycle that is an open loop or semi-closed loop cycle, the first power producing cycle comprising:
a combustor configured for combusting a solid fuel with an oxidant in the presence of a recycle CO₂ stream and outputting a combustor exhaust stream;
at least one power producing member configured to receive at least a portion of the combustor exhaust stream, generate power, and output a turbine exhaust stream; and
one or more elements configured for recycling at least a portion of the combustor exhaust stream back to the combustor; and
a second power producing cycle that is a closed loop cycle utilizing CO₂ as a working fluid, the second power producing cycle comprising:
at least one power producing member configured to receive the CO₂ working fluid and generate power;
wherein the power generation system includes at least one heating member configured to receive the CO₂ working fluid from the second power producing cycle and transfer heat thereto from a stream generated from the first power producing cycle.

2. The power generation system of claim 1, wherein the first power producing cycle includes a filter unit configured for removal of at least a portion of any solids present in the combustor exhaust stream.

3. The power generation system of claim 2, wherein the filter unit includes one or both of a cyclone filter and a candle filter.

4. The power generation system of claim 2, wherein the filter unit is configured for output of a solids stream comprising at least fuel ash and a combustion flue gas stream comprising at least CO₂.

5. The power generation system of claim 4, wherein the at least one power producing member of the first power production cycle is configured to receive the combustion flue gas stream from the filter unit.

6. The power generation system of claim 1, wherein the first power production cycle comprises a first heat exchanger configured to withdraw heat from the turbine exhaust stream.

7. The power generation system of claim 6, further comprising a water separator configured for receiving the turbine exhaust stream exiting the first heat exchanger and outputting a water stream and a CO₂ stream.

8. The power generation system of claim 7, further comprising one or both of a compressor and a pump configured for pressurizing the CO₂ stream.

9. The power generation system of claim 8, wherein the first heat exchanger comprises a hot input configured to receive the turbine exhaust stream, a cold output configured to output the turbine exhaust stream, a cold input configured to receive the CO₂ stream, and a hot output configured to output the CO₂ stream for recycle back to the combustor.

10. The power generation system of claim 4, wherein the at least one heating member configured to receive the CO₂ working fluid from the second power producing cycle and transfer heat thereto from a stream generated from the first power producing cycle is a solids cooler configured to receive the solids stream from the filter unit.

11. The power generation system of claim 10, further comprising a recycle line configured for recycle of solids from the solids cooler to the combustor of the first power producing cycle.

12. The power generation system of claim 1, wherein the combustor comprises a flame zone configured for combusting the solid fuel with the oxidant and a downstream scrubbing zone configured for receiving a sulfur scrubbing component.

13. The power generation system of claim 1, wherein the combustor comprises a solid fuel inlet, and oxidant inlet, and a sulfur scrubbing component inlet.

14. The power generation system of claim 13, wherein the combustor further comprises one or both of a recycle CO₂ inlet and a recycle solids inlet.

15. The power generation system of claim 1, further comprising a scrubbing reactor downstream from the combustor, the scrubbing reactor being configured for receiving at least a portion of the combustor exhaust stream and a sulfur scrubbing component.

16. A method for power generation comprising:
combusting a solid fuel in a combustor with an oxidant in the presence of a compressed, recycle CO₂ stream to form a combustor exhaust stream;
filtering the combustor exhaust stream in a filter unit to remove solids from the combustor exhaust stream and provide a combustor flue gas stream;
passing the combustor flue gas stream through a first turbine for power generation to provide a turbine exhaust stream;
processing the turbine exhaust stream to provide the compressed, recycle CO₂ stream to the combustor;
transferring the solids removed from the combustor exhaust stream to a heating member;
circulating a CO₂ working fluid through a closed loop cycle such that the CO₂ working fluid is compressed, heated with heat from the solids in the heating member, and expanded through a second turbine for power generation.

17. The method of claim 16, wherein the combusting is carried out at a temperature of about 600° C. to about 1,200° C.

18. The method of claim 17, wherein the combusting is carried out at a pressure that is above ambient and up to about 70 bar.

19. The method of claim 16, wherein the combusting is carried out such that substantially none of the CO₂ present in the combustor is in a supercritical condition.

20. The method of claim 16, wherein the combusting is carried out at a pressure of about 80 bar to about 500 bar.

21. The method of claim 16, wherein, prior to said filtering, the method further comprises adding a sulfur scrubbing component to the combustor exhaust stream.

22. The method of claim 16, wherein, prior to said passing the combustor flue gas stream through the first turbine, the method further comprises adding an amount of gaseous fuel to the combustor flue gas stream.

23. The method of claim 16, wherein said processing the turbine exhaust stream to provide the compressed, recycle CO₂ stream comprises:
cooling the turbine exhaust stream in a recuperator heat exchanger;
passing a cooled turbine exhaust stream from the recuperator heat exchanger through a water separator to output a water stream and a stream of substantially pure CO₂;
compressing the stream of substantially pure CO2 to a pressure suitable for input to the combustor; and
heating the stream of substantially pure CO₂ in the recuperator heat exchanger using at least heat withdrawn from the turbine exhaust that was cooled.

24. The method of claim 23, wherein said compressing comprises using one or both of a compressor and a pump.

25. The method of claim 23, wherein the turbine exhaust is passed into the recuperator heat exchanger through a hot input, the cooled turbine exhaust stream exits the heat exchanger through a cold output, the stream of substantially pure CO₂ enters the recuperator exchanger through a cold input, and the stream of substantially pure CO₂ exits the recuperator exchanger through a hot output for recycle back to the combustor.

26. The method of claim 16, wherein the filter unit includes one or both of a cyclone filter and a candle filter.

27. The method of claim 16, the solids removed from the combustor exhaust stream and transferred to the heating member are at least partially recycled back to the combustor.
